(19) United States
(12) Patent Application Publication
(10) Pub. No.: US 2026/0326482 A1
(43) Pub. Date: Oct. 22, 2026

(54) OIL FILTER FOR VEHICLE AXLE AND WHEEL HUB ASSEMBLY

(71) Applicant: Adam Price, Springfield, OH (US)

(72) Inventor: Adam Price, Springfield, OH (US)

(21) Appl. No.: 19/184,193

(22) Filed: Apr. 21, 2025

(51) Int. Cl. B60B 27/02; F16C 19/38; F16C 33/66

(52) U.S. Cl. CPC B60B 27/02; F16C 19/38; F16C 33/6637; B60B 2380/14; B60B 2900/20; B60B 2900/561; F16C 2326/02

(57) ABSTRACT

A wheel hub assembly with an integrated oil filter for filtering oil for wheel bearings is provided. The wheel hub assembly includes an axle, a wheel hub rotatably coupled to the axle, and a hubcap mounted on the wheel hub. An interior volume of the combination of wheel hub and hubcap forms an oil enclosure that contains the oil for lubricating the wheel bearings. A filter element is installed on an end portion of the axle inside the oil enclosure. The filter element has a central opening that is sized to fit around the axle so that the filter element may be installed in a position surrounding the axle. The filter element may be installed in a position on the axle that is outside of an outer bearing or in a position that is between the outer bearing and an inner bearing.

### FIELD OF THE DISCLOSURE

The present disclosure relates to vehicle axle and wheel hub assemblies for vehicle wheels, and more particularly to a vehicle axle and wheel hub assembly with an integrated oil filter for filtering oil for wheel bearings.

### BACKGROUND

Hubcaps have long been used on vehicle wheels to protect wheel components and provide an aesthetically pleasing appearance. In heavy-duty vehicle applications, such as large trucks and trailers, hubcaps are often designed for the specific function of containing lubricating oil for wheel bearings. These oil-containing hubcaps have an oil reservoir to hold a supply of oil that lubricates the wheel bearings during operation of the vehicle. While oil lubrication can extend the life of wheel bearings compared to grease lubrication, the oil in the hubcap reservoir can become contaminated over time. Metal particles, dirt, debris, and other contaminants can accumulate in the oil as the bearings wear or as external elements enter the hubcap. This contamination can reduce the effectiveness of the lubrication and potentially lead to increased wear or damage to the bearings. Periodic oil changes are typically performed to remove contaminated oil and replenish the oil reservoir with fresh oil. However, this maintenance task requires time and labor and results in vehicle downtime. There is a general desire in the industry to extend the intervals between oil changes while still maintaining proper lubrication of wheel bearings.

Filtration is a common technique used in other lubrication systems for vehicles, such as engine oil systems, or other types of motors used in various applications to remove contaminants and extend the useful life of the lubricating oil. However, the use of filtration systems in oil-containing hubcap systems is generally lacking in the industry. Integrating effective filtration into the limited space of a wheel hub or hubcap installed on the wheel hub presents challenges. Any filtration system added to a wheel hub or hubcap must be compact but also capable of effectively filtering various types of contaminants from the oil while maintaining proper bearing lubrication. Such a filtration system should also be durable to withstand harsh operating conditions, easy to install and remove from the wheel hub or hubcap, and configured to allow sufficient oil flow throughout the interior of the wheel hub or hubcap. Such improvements have the potential to extend oil change intervals, reduce maintenance costs, and improve overall wheel-end reliability for heavy-duty vehicles.

### SUMMARY

In one aspect, a wheel hub assembly with a filter element for filtering oil for wheel bearings is provided. The wheel hub assembly comprises an axle, a wheel hub rotatably coupled to the axle, and a hubcap mounted onto the wheel hub. An interior volume of the wheel hub and hubcap define an oil enclosure. An end portion of the axle is disposed within the oil enclosure. The filter element has a central opening extending through the filter element, and the filter element is disposed around an exterior of the end portion of the axle with the end portion of the axle extending through the central opening in the filter element so that the filter element is also disposed within the oil enclosure. The wheel hub assembly may include an inner bearing and an outer bearing for supporting the wheel hub on the axle. The filter element may be disposed at a distal position on the axle that is outside of the outer bearing, or the filter element may be disposed at a position on the axle that is between the inner bearing and the outer bearing.

In one embodiment, the central opening of the filter element may be defined by a threaded opening having helical threads that are compatible with helical threads on the end portion of the axle. The filter element may be threaded onto the axle to retain the filter element in a fixed position on the end portion of the axle. The threaded filter element may serve a dual function as both a filter and a fastener to secure the wheel hub on the axle. Alternatively, a separate fastener such as one or more threaded nuts may be utilized in combination with the filter element. The filter element may comprise a barrier filtration media, one or more magnets configured to remove metal shavings from the oil, or a combination of magnets and barrier filtration media. The barrier filtration media may be utilized to remove dirt, debris, or any other type of contaminant capable of being removed through barrier filtration of oil. The filter element has openings that define passageways that allow the flow of oil through the filter element.

The hubcap may comprise a hubcap body, a fastening ring, a transparent viewing window having an opening extending through the viewing window, and a plug configured to be installed within the opening in the viewing window to seal the opening. The plug may have a pressure relief opening extending through the plug. The hubcap body may be mounted directly onto the wheel hub, and the viewing window and fastening ring may be used to cap an open distal end of the hubcap body to seal the oil enclosure. The hubcap body may have helical threads configured to mate with helical threads on the wheel hub for mounting the hubcap body onto the wheel hub or, alternatively, may be mounted using a flange and bolts. The transparent viewing window allows a user to view an oil level within the oil enclosure from an exterior of the hubcap. As oil moves within the oil enclosure and through the filter element during operation of the vehicle, the filter element removes contaminants from the oil and retains the contaminants on or within the filter element. The design of the filter element effectively removes contaminants from the oil to extend the life of the oil between oil changes and thus enhance bearing lubrication through extended periods of use.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### DESCRIPTION OF THE DRAWINGS

These and other features, aspects, and advantages of the present invention will become better understood with regard to the following description, appended claims, and accompanying drawings where:

FIG. 1 shows a perspective view of a wheel hub assembly with a hubcap in accordance with the present disclosure.

FIG. 2 shows an exploded view of a wheel hub assembly with a filter element in accordance with the present disclosure.

FIG. 3 shows an exploded view of a hubcap and a wheel hub assembly with a filter element in accordance with the present disclosure.

FIG. 4 shows a plan view of a filter element for use with a wheel hub and hubcap in accordance with the present disclosure.

FIG. 5A shows a side view of a filter element for use with a wheel hub and hubcap in accordance with the present disclosure.

FIG. 5B shows a cross-sectional view of a filter element for use with a wheel hub and hubcap in accordance with the present disclosure.

FIG. 6 shows a perspective view of a filter element for use with a wheel hub and hubcap in accordance with the present disclosure.

FIG. 7 shows a plan view of a filter element for use with a wheel hub and hubcap in accordance with the present disclosure.

FIG. 8 shows an exploded view of a filter element for use with a wheel hub and hubcap in accordance with the present disclosure.

FIG. 9 shows a perspective view of a filter element for use with a wheel hub and hubcap in accordance with the present disclosure.

FIG. 10 shows a perspective view of a filter element for use with a wheel hub and hubcap in accordance with the present disclosure.

FIG. 11 shows a cross-sectional view of a filter element for use with a wheel hub and hubcap in accordance with the present disclosure.

FIG. 12 shows a cross-sectional view of a hubcap installed on a wheel hub assembly with a filter element in accordance with the present disclosure.

FIG. 13 shows a cross-sectional view of a hubcap installed on a wheel hub assembly with a filter element in accordance with the present disclosure.

FIG. 14 shows a cross-sectional view of a hubcap installed on a wheel hub assembly with a filter element in accordance with the present disclosure.

FIG. 15 shows a perspective view of a filter element for use with a wheel hub and hubcap in accordance with the present disclosure.

FIG. 16 shows a top view of a filter element for use with a wheel hub and hubcap in accordance with the present disclosure.

FIG. 17 shows a cross-sectional view of a hubcap installed on a wheel hub assembly with a filter element in accordance with the present disclosure.

FIG. 18 shows a side view of a filter element for use with a wheel hub and hubcap in accordance with the present disclosure.

FIG. 19 shows a cross-sectional view of a hubcap installed on a wheel hub assembly with a filter element in accordance with the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

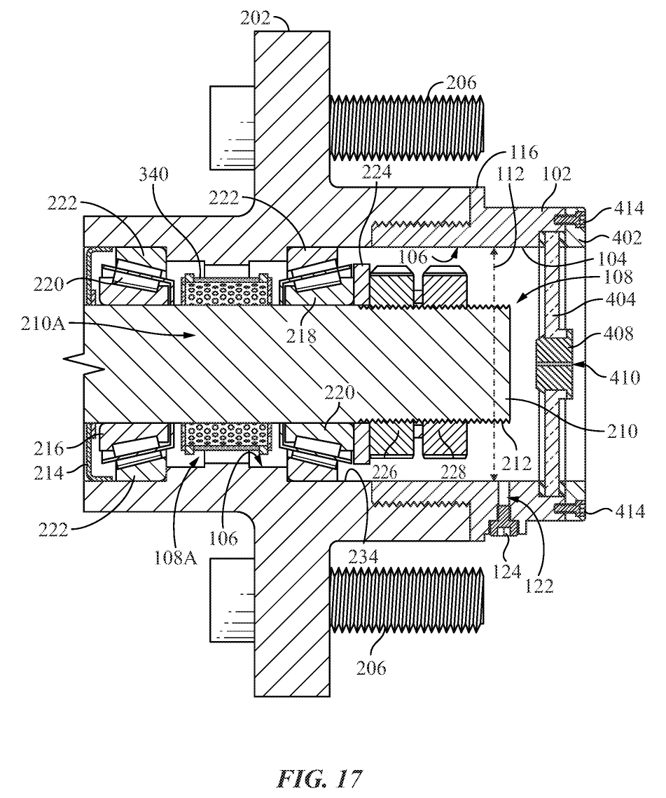

In one aspect, a wheel hub assembly 200 with a filter element 300 for filtering oil for lubricating wheel bearings 216, 218 is provided. The wheel hub assembly comprises an axle 204, a wheel hub 202 rotatably coupled to and positioned around the axle 204, and a hubcap 100 mounted onto the wheel hub 202. An interior volume of the wheel hub 202 and hubcap 100 define an oil enclosure 108. An end portion 210 of the axle 204 is disposed within the oil enclosure 108. The filter element 300 has a central opening 312 extending through the filter element 300, and the filter element 300 is disposed around an exterior of the end portion 210 of the axle 204 with the end portion 210 of the axle 204 extending through the central opening 312 in the filter element 300 so that the filter element 300 is also disposed within the oil enclosure 108, as best seen in FIG. 12. The wheel hub assembly 200 may include an inner bearing 216 and an outer bearing 218 for supporting the wheel hub 202 on the axle 204. As best seen in FIG. 12-14, the filter element 300 may be disposed at a distal position on the axle 204 that is outside of the outer bearing 218. Alternatively, as best seen in FIGS. 17 and 19, a filter element 340 may be disposed at a position on the axle 204 that is between the inner bearing 216 and the outer bearing 218.

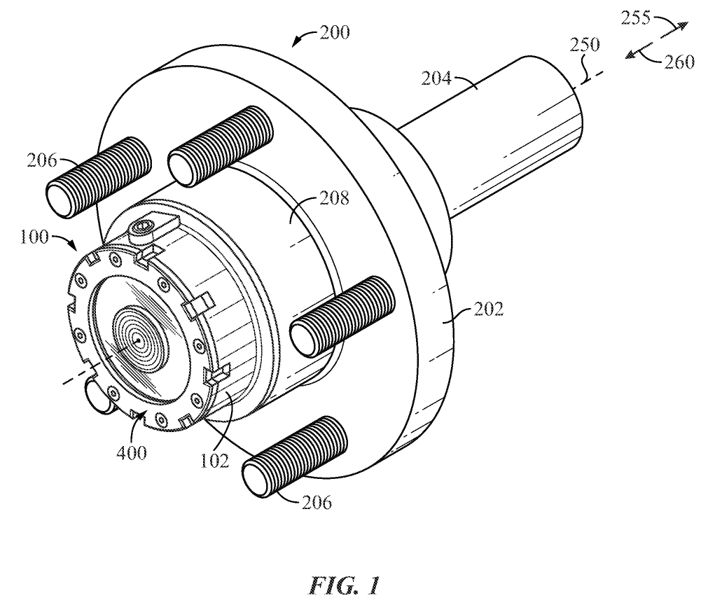

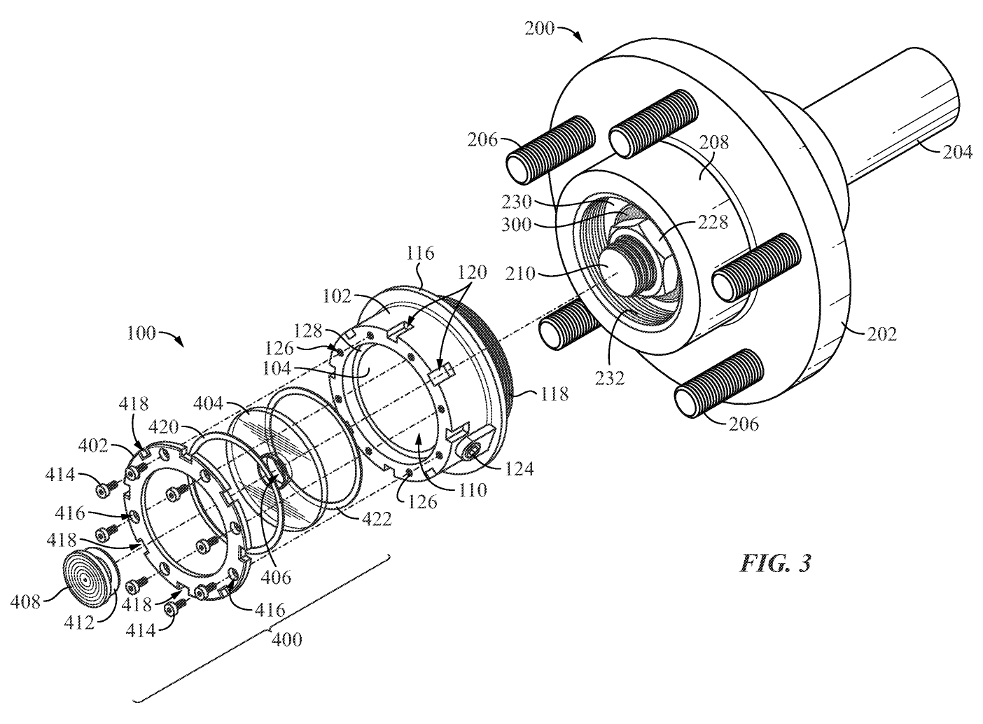

The hubcap 100 may comprise an assembly that includes a hubcap body 102 configured to be removably mounted onto the wheel hub 202. FIG. 1 shows a wheel hub assembly 200 with the hubcap body 102 mounted thereon. The hubcap body 102 may have an open distal end 110, as best seen in FIG. 3. The hubcap 100 may further comprise a cap assembly 400 configured to cap an open distal end 112 of the hubcap body 102. When the cap assembly 400 is installed on the hubcap body 102, the oil enclosure 108 may be sealed to prevent leakage of oil from the oil enclosure 108 around sealed components. When the hubcap 100 is mounted onto the wheel hub 202, the combination of wheel hub 202 and hubcap 100 form the sealed oil enclosure 108 to contain the oil for lubricating bearings 216 and 218.

The wheel hub 202 is supported on the axle 204 by at least one bearing, and preferably by both inner bearing 216 and outer bearing 218, so that the wheel hub 202 and wheel mounted thereon may rotate about the axle 204. As used herein, an “axle” may refer to any component of a vehicle that provides a structure for rotatably coupling a wheel hub 202 thereto. The vehicle may include any type of motorized or non-motorized vehicle having wheels that may be used for transporting people or goods, including, but not limited to, motorized vehicles such as a tractor unit of a semi-trailer or tractor-trailer, dump trucks, buses, cars, recreational vehicles (RV), motor homes, farm equipment, mining vehicles, electric conveyance vehicles (ECV), or aircraft, and non-motorized vehicles such as a trailer or semi-trailer, which may include enclosed cargo trailers, flatbed trailers, boat trailers, vehicle trailers, livestock trailers, or dollies. The wheel hub 202 may have outwardly facing bolts 206 for mounting a wheel on the hub 202. The hub 202 rotates about a central axis 250 when the vehicle is in motion so that the wheel mounted on the hub 202 rotates with the hub 202. As used herein, an axially inward direction refers to a direction extending toward the axle 204, and an axially outward direction refers to a direction extending away from the axle 204 toward the cap assembly 400 that is accessible from the exterior of the hubcap 100. As illustrated in FIG. 1, arrow 255 indicates an axially inward direction, and arrow 260 indicates an axially outward direction. As used herein, a “distal” end or “distal” side of any component of the wheel hub assembly 200 or a “distal” direction refers to an end, side, or direction toward the axially outward direction 260. Similarly, a “proximal” end or “proximal” side of any component of the wheel hub assembly 200 or a “proximal” direction refers to an end, side, or direction toward the axially inward direction 255.

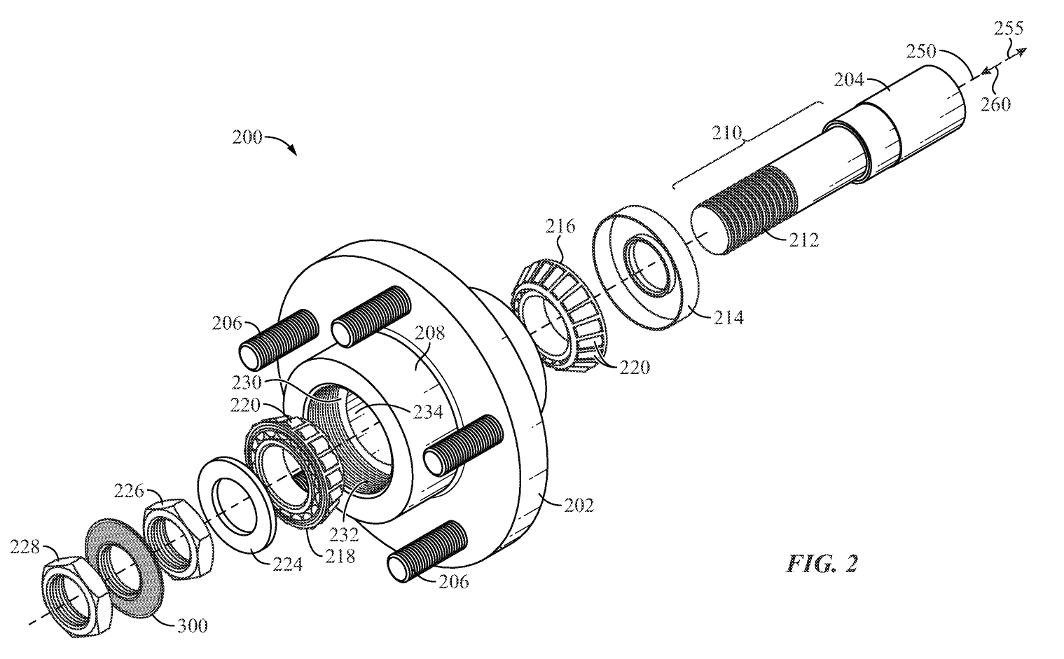

The wheel hub 202 may have a hubcap 100 mounting portion 208 that extends axially outward from the hub 202. As best seen in FIG. 2, mounting portion 208 of the wheel hub 202 preferably has helical female threads 232 that are compatible with and configured to mate with helical male threads 118 attached to the hubcap body 102, as best seen in FIG. 3. FIG. 1 shows the male threads 118 fully threaded into the mounting portion 208 of the wheel hub 202 to mount the hubcap body 102 onto the wheel hub 202. To facilitate installing the threaded hubcap body 102 of the hubcap 100 on the wheel hub 202 and removing the hubcap body 102 from the wheel hub 202, the hubcap body 102 may have a plurality of elongated channels 120 formed into the hubcap body 102 on an exterior surface of the hubcap body 102. The elongated channels 120 may be equidistantly spaced around a perimeter of the hubcap body 102 and may be designed for use with a specialized wrench configured to engage the hubcap body 102 at each of the elongated channels 120 to apply torque to the hubcap body 102 to thread the hubcap body 102 onto or off of the mounting portion 208 of the wheel hub 202. Alternatively, the hubcap body 102 or other portions of the hubcap 100 may have other shapes suitable for engaging with a wrench for applying torque for installation or removal of the threaded hubcap body 102. The hubcap body 102 may have a mounting flange 116 that fits against a distal end of the mounting portion 208 of the wheel hub 202 when the hubcap body 102 is fully threaded into the mounting portion 208 of the wheel hub 202, as best seen in FIGS. 1 and 12. Alternatively, the mounting flange 116 may have openings extending through the mounting flange 116 for mounting the hubcap body 102 onto the wheel hub 202 using threaded fasteners such as bolts, in which case the distal end of the mounting portion 208 of the wheel hub 202 may have corresponding threaded bolt holes for receiving the fastener bolts therein. In embodiments utilizing bolts for fastening the hubcap 100 onto the wheel hub 202, the hubcap body 102 may or may not include elongated channels 120.

The hubcap body 102 may have a generally cylindrical shape. Alternatively, the hubcap body 102 may have other suitable shapes. For instance, the hubcap body 102 may be tapered as the body 102 extends toward the distal end 110, in which case the hubcap body 102 may have a truncated conical shape. The hubcap body 102 is generally a housing having a continuous interior wall 104 that forms a portion of the oil enclosure 108. When the hubcap 100 is mounted on the wheel hub 202, the oil enclosure 108 may be generally defined by interior surfaces 106 of the interior wall 104 of the hubcap body 102 and an interior wall 234 of the wheel hub 202. Opposing ends of the oil enclosure 108 may be further defined by portions of the cap assembly 400 at an axially outward end of the oil enclosure 108 and a seal 214 that prevents loss of oil from the oil enclosure 108 at an axially inward end of the oil enclosure 108. The interior surfaces 106 of the wheel hub 202 and hubcap body 102 may extend continuously around a perimeter of the oil enclosure 108. When threads 118 of the hubcap body 102 are fully mated with threads 232 of the wheel hub 202, the hubcap body 102 and wheel hub 202 may be configured for a proximal end of the hubcap body 102 to fit against an interior edge 230 of the wheel hub 202 so that the interior surfaces 106 of the oil enclosure 108 are flush at the location where the proximal end of the hubcap body 102 meets the wheel hub 202.

As best seen in FIG. 12, the hubcap body 102 may have a drain port 122 that is closed during normal use by a drain plug 124. The drain port 122 may define a threaded opening having threads that are compatible with threads on the drain plug 124 to allow the drain plug 124 to seal the drain port 122 closed and to remove the drain plug 124 to drain oil from the oil enclosure 108 to periodically change the oil. The drain port 122 is preferably positioned on a distal side of the filter element 300. Fresh oil may also be added into the oil enclosure 108 through the drain port 122 after draining the used oil.

The filter element 300 is disposed within the oil enclosure 108. The filter element 300 extends transversely across a width 112 of the oil enclosure 108 between interior surfaces 106 of the oil enclosure 108 on opposing sides of the oil enclosure 108, preferably around a circular perimeter of the oil enclosure 108. The filter element 300 is preferably disposed in a position generally perpendicular to the interior wall 104 of the hubcap body 102 and/or interior wall 234 of the wheel hub 202. Preferably, the filter element 300 has a generally circular shape that defines an outer peripheral edge 316, 328 of the filter element 300. Similarly, the oil enclosure 108 preferably also has a generally circular interior cross-sectional shape defined by the interior surfaces 106 of the oil enclosure 108. The outer diameter of the filter element 300 is preferably sized so that the filter element 300 extends transversely across a substantial portion of a cross-sectional area of the oil enclosure 108, as best seen in FIG. 12, but the outer diameter of the filter element 300 is smaller than an inner diameter 112 of the oil enclosure 108 at the location within the oil enclosure 108 at which the filter element 300 is disposed. This configuration provides a gap 114 between the outer peripheral edge 316, 328 of the filter element 300 and the interior surface 106 of the oil enclosure 108 around a perimeter of the filter element 300 to ensure that the interior surfaces 106 of the hubcap body 102 or wheel hub 202 do not contact the filter element 300 during normal use of the vehicle at which time the wheel hub 202 and attached hubcap 100 rotate on the stationary axle 204 as the wheels of the vehicle rotate.

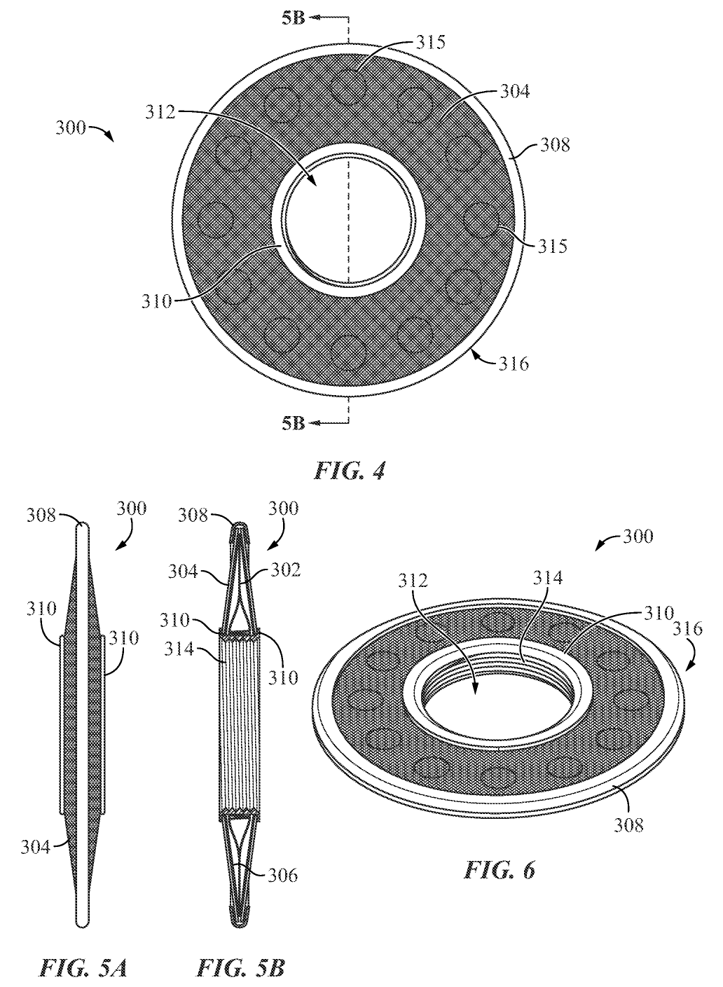

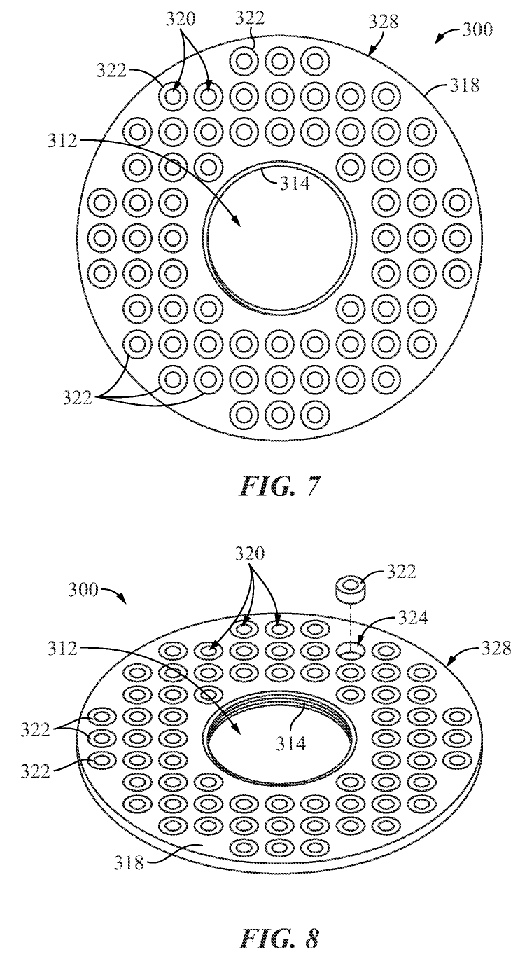

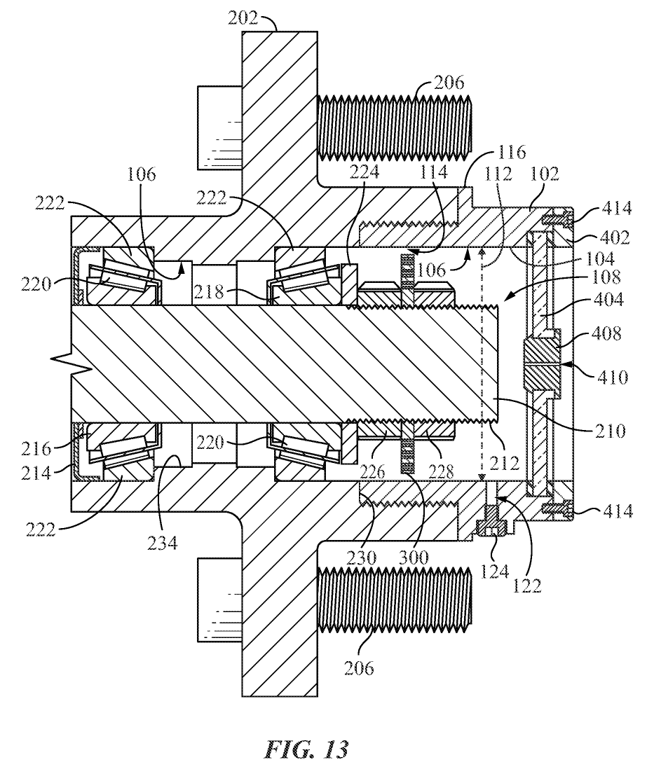

FIG. 2 shows an exploded view of the wheel hub assembly 200 with a filter element 300. FIG. 3 shows an exploded view of components of the hubcap 100 and the wheel hub assembly 200, and FIG. 12 shows a cross-sectional view of the assembled wheel hub assembly 200. FIGS. 2, 3, and 12 show the wheel hub assembly 200 utilizing the filter element 300 shown in FIGS. 4-6. FIGS. 7-11, 15, 16, and 18 show other possible embodiments of filter elements 300, 340 that may be utilized with the present wheel hub assembly 200. Each of FIGS. 13, 14, 17, and 19 shows a cross-sectional view of the wheel hub assembly 200 with various types of filter elements 300, 340 that may be utilized. It should be understood by one of skill in the art that other embodiments of filter elements 300, 340 may also be utilized and still fall within the scope of the present disclosure.

The filter element 300 is disposed around a circumference of the end portion 210 of the axle 204 and is configured to remove at least one type of contaminant from oil contained in the oil enclosure 108. As oil splashes and otherwise moves within the oil enclosure 108 and through the filter element 300 during operation of the vehicle, the filter element 300 may remove contaminants from the oil and retain the contaminants on or within the filter. The filter element 300 may comprise a barrier filtration media, one or more magnetic elements configured to remove metal shavings from the oil, or a combination of magnetic elements and barrier filtration media. The barrier filtration media may be utilized to remove dirt, debris, or any other type of contaminant capable of being removed through barrier filtration of oil. The filter element 300 has openings that define passageways that allow the flow of oil through the filter element 300. The design of the filter element 300 effectively removes contaminants from the oil to extend the life of the oil between oil changes and thus enhance bearing lubrication through extended periods of use

FIGS. 4-6 illustrate a disc filter element 300 that may be used with the cap assembly 400 to filter oil contained within the oil enclosure 108 via barrier filtration. The filter element 300 has a central opening 312 that extends through the filter element 300 such that the filter element 300 has a generally annular shape. The end portion 210 of the axle 204 may be received within the central opening 312 and inserted through the central opening 312 to install the filter element 300 on the end portion 210 of the axle 204. The central opening 312 of the filter element 300 is generally sized to fit around the end portion 210 of the axle 204 with the filter element 300 being disposed around an exterior of the end portion 210 of the axle 204 such that the end portion 210 of the axle 204 extends through the central opening 312 in the filter element 300. In one embodiment, as best seen in FIG. 6, the central opening 312 of the filter element 300 may be defined by a threaded opening having helical threads 314. As best seen in FIG. 2, the end portion 210 of the axle 204 preferably has a threaded section having helical threads 212, which may be utilized for fastening the wheel hub 202 onto the axle 204 using a spindle nut 226, torque nut, or other similar type of threaded fastener. The helical threads 314 of the threaded central opening 312 of the filter element 300 are compatible with the helical threads 212 on the end portion 210 of the axle 204. Thus, the filter element 300 may be threaded onto the end portion 210 of the axle 204 to retain the filter element 300 in a fixed axial position on the end portion 210 of the axle 204. Alternatively, the central opening 312 may be sized to allow the filter element 300 to slide onto the end portion 210 of the axle 204 without threading or otherwise rotating the filter element 300, in which case the central opening 312 may not include threads 314. If threads 314 are not utilized, the central opening 312 of the filter element 300 and the end portion 210 of the axle 204 are preferably sized to provide a transition fit between the filter element 300 and the end portion 210 of the axle 204, which may allow a user to manually slide the filter element 300 onto the end portion 210 of the axle 204 with minimal, if any, clearance between the filter element 300 and the end portion 210 of the axle 204. Thus, the filter element 300 may be manually installed with a fit that generally does not allow movement of the filter element 300 within the oil enclosure 108 in a radial direction relative to axis 250.

The wheel hub 202 is supported on the axle 204 by at least one bearing, and preferably by inner bearing 216 and outer bearing 218, so that the wheel hub 202 and a wheel mounted thereon may rotate about the axle 204. As best seen in FIGS. 12 and 17, bearings 216 and 218 are spaced apart such that a portion 108A of oil enclosure 108 is disposed between the inner bearing 216 and outer bearing 218. Preferably, as best seen in FIG. 2, each of bearings 216 and 218 may be a tapered roller bearing each having a series of rollers 220. Alternatively, other suitable types of bearings may be utilized, which may use other suitable types of rolling elements. As best seen in FIG. 12, the wheel hub assembly 200 may include corresponding tapered races 222 having surfaces that rollers 220 may contact as the wheel hub 202 rotates. The bearings 216 and 218 are disposed within the oil enclosure 108, and oil may flow across each of the bearings 216 and 218 during normal use so that the oil may lubricate the bearings 216 and 218. The wheel hub assembly 200 may further comprise a seal 214 disposed on a proximal side of the inner bearing 216 to prevent the loss of oil from the oil enclosure 108.

To install the wheel hub assembly 200 with the filter element 300, the wheel hub 202, inner bearing 216, and outer bearing 218 may first be installed on the end portion 210 of the axle 204. Inner bearing 216 may be installed on the axle 204 first. The wheel hub 202 may then be positioned around the end portion 210 of the axle 204 with inner bearing 216 contact the corresponding race 222, and the outer bearing 218 may then be installed on the end portion 210 of the axle 204. The wheel hub 202 may then be secured to the axle 204 with a threaded fastener 226, which may be a spindle nut. Preferably, a washer 224 may be installed between the outer bearing 218 and the spindle nut 226 that secures the wheel hub 202 and bearings 216 and 218 on the end portion 210 of the axle 204. The spindle nut 226 is then threaded onto the helical threads 212 of the axle 204 to fasten the hub 202 to the axle 204.

Next, the filter element 300 may be installed onto the end portion 210 of the axle 204 at a position that is distal to the outer bearing 218 and spindle nut 226, as best seen in FIG. 12. The filter element 300 with helical threads 314 may be threaded onto the helical threads 212 of the axle 204. In this case, the threaded filter element 300 may serve a dual function as both a filter and as a second fastener to ensure that the spindle nut 226 remains in place to secure the wheel hub 202 on the axle 204. Alternatively, a separate threaded fastener 228 having helical threads that are compatible with threads 212 on the axle 204 may optionally be used to retain the filter element 300 in a fixed position on the end portion 210 of the axle 204. In one embodiment in which the threaded filter element 300 is used as a fastener, the filter element 300 may optionally include a distally extending portion having angled edges configured to allow engagement with a wrench to install or remove the filter element 300. For instance, the filter element 300 may be permanently attached to threaded nut 228 by welding to form a unitary fastener and filter assembly having continuous threads extending through the unitary assembly for threading the unitary assembly onto threads 212 of the axle 204. If the filter element 300 does not include threads 314, the filter element 300 may be installed on the end portion 210 of the axle 204 by sliding the filter element 300 onto the end portion 210 after the spindle nut 226 is installed. Threaded nut 228 may then be used to secure the filter element 300 on the end portion 210 of the axle 204. As best seen in FIG. 12, the filter element 300 extends radially outward from the axle 204 beyond threaded fasteners 226 and 228 to provide an area of filtration having a generally annular shape and being disposed between the inner surfaces 106 that define the oil enclosure 108 and an exterior of the end portion 210 of the axle 204 or an exterior of fasteners 226 and 228. Oil inside the oil enclosure 108 may pass through this annular portion of the filter element 300 to filter out contaminants from the oil.

To complete the installation of the wheel hub assembly 200, the hubcap 100 may be installed on the wheel hub 202. The hubcap body 102 may first be mounted onto the wheel hub 202, and the cap assembly 400 may then be installed to cap the open distal end 110 of the hubcap body 102 to seal the oil enclosure 108. As best seen in FIGS. 3 and 12, the cap assembly 400 may comprise a fastening ring 402, a transparent viewing window 404 having an opening 406 extending through the viewing window 404, and a plug 408 configured to be installed within the opening 406 in the viewing window 404 to seal the opening 406. The cap assembly 400 may further comprise a distal gasket 420 and a proximal gasket 422 positioned on opposite sides of the viewing window 404 to form a seal between the cap assembly 400 and the hubcap body 102. The cap assembly 400 may be installed on the hubcap body 102 or removed from the hubcap body 102 using common tools so that the filter element 300 and threaded fasteners 226 and 228 may be accessed through the open distal end 110 of the hubcap body 102. In an alternative embodiment, components forming the cap assembly 400 may be permanently attached to the distal end of the hubcap body 102, in which case the entire hubcap body 102 may be made of a transparent material to allow visual observation of the oil contained within the hubcap body 102. In this case, the filter element 300 and threaded fasteners 226 and 228 may be accessed by removal of the hubcap body 102 from the wheel hub 202.

To install the cap assembly 400, the proximal gasket 422 may first be installed in the hubcap body 102. The interior wall 104 of the hubcap body 102 preferably has an interior edge 128 sized and configured so that the proximal gasket 422 may be positioned flat against the interior edge 128 when installed. The transparent viewing window 404 may then be placed against the proximal gasket 422, and the distal gasket 420 may be placed against the opposing distal side of the viewing window 404. To complete the installation of the cap assembly 400 on the hubcap body 102, the fastening ring 402 may be placed against the distal gasket 420, as shown in FIG. 12, and the fastening ring 402 may be fastened to the hubcap body 102 using bolts 414. As shown in FIG. 3, the fastening ring 402 may have bolt openings 416 for insertion of the bolts 414 therethrough, and the distal end of the hubcap body 102 may have corresponding threaded openings 126 compatible with threads on bolts 414 and configured to receive bolts 414 therein to tightly secure the installation of the cap assembly 400 so that the distal end 110 of the hubcap body 102 is sealed. The fastening ring 402 may have a plurality of notches 418 equidistantly spaced around a perimeter of the fastening ring 402 and configured to align with the plurality of elongated channels 120 on the exterior of the hubcap body 102, as shown in FIG. 1, to allow a specialized wrench to engage the hubcap 100 to apply torque for installing or removing the hubcap 100.

The plug 408 may then be installed within the opening 406 in the viewing window 404 to fully complete the installation. The plug 408 may be made of a deformable elastomeric material, such as rubber or a similar polymeric material, and may have a lip 412 extending around a perimeter of a proximal end of the plug 408 to retain the plug 408 within opening 406 after insertion into the opening 406. As best seen in FIG. 12, the plug 408 may have a pressure relief opening 410 extending through the plug 408. The pressure relief opening 410 may be a slit or small borehole extending through the plug 408 to allow equalization of pressure between the oil enclosure 108 and the external atmosphere while preventing or minimizing any amount of dirt, debris, or moisture that may enter the oil enclosure 108 through the opening 410 and also preventing or minimizing any potential leakage of oil from the oil enclosure 108.

Once the cap assembly 400 is fully installed, the transparent viewing window 404 allows a user to visually observe an oil level within the holding chamber 110 from an exterior of the hubcap 100. The viewing window 404 may be made of a generally transparent material such as plastic or glass. Thus, the user may observe whether there is an adequate amount of oil inside the oil enclosure 108 to determine if additional oil should be added. The user may also observe the color of the oil to determine the oil quality and thus whether the oil should be changed. As oil moves within the interior of the oil enclosure 108 and through the filter element 300, 340 during operation of the vehicle, the magnetic and/or barrier filter elements may remove contaminants from the oil and retain the contaminants on or within the filter elements.

As best seen in FIG. 5B, the disc filter element 300 may comprise two opposing wire mesh filters 304 supported by a perforated support plate 302 that is disposed between the wire mesh filters 304. The filter element 300 may include an outer clamping ring 308 and two inner clamping rings 310. Each of the clamping rings 308, 310 may have a C-shaped channel that can be clamped onto components of the filter element 300. The outer clamping ring 308 may have an inwardly facing channel that is clamped to retain the support plate 302 and both of the wire mesh filters 304. The inner clamping rings 310 may each have an outwardly facing channel that is clamped to retain a respective one of the wire mesh filters 304. The filter element 300 may optionally include an additional layer of a mesh filter 306 disposed on the inner side of each of the wire mesh filters 304 to provide an additional layer of filtration. The optional additional mesh filters 306 may also be retained by the outer clamping ring 308 and a respective one of the inner clamping rings 310. The support plate 302 has a plurality of perforations or openings 315 (visible through mesh filter 304 in FIGS. 4 and 6) to allow oil to flow through the support plate 302, which is preferably made of a non-permeable material such as metal, by flowing through the mesh filters 304 and the openings 315.

The support plate 302 may have bends in a portion of the plate 302 adjacent to the central opening 312 or other structural elements so that the filter element 300 has a greater width near the central opening 312 than at the outer peripheral edge 316 of the filter element 300. The support plate 302 may flatten as the support plate 302 extends from the central opening 312 toward the outer clamping ring 308 at the outer peripheral edge 316 of the filter element 300, as shown in FIG. 5B. Each of the inner clamping rings 310 may be attached to opposing sides of the support plate 302 at a position generally adjacent to the central opening 312 so that the inner clamping rings 310 define an edge of the central opening 312. As best seen in FIG. 6, the helical threads 314 that define the central openings 312 may extend between the two inner clamping rings 310.

The wire mesh filters 304 may comprise a plurality of woven wires having a plurality of openings extending through the mesh and being defined by spaces between the woven wires. The woven wires may be made of stainless steel, copper, or another suitable material. The woven wires may be sintered so that the individual wires are bonded to each other at each intersection of wires. Each mesh filter 304 may be a surface filter designed to remove contaminants from the oil as the oil passes through the openings in the mesh. In some embodiments, the surface filter may have pore sizes up to about 2,000 microns and preferably ranging from about 25 to 750 microns. In one embodiment, one or both of the mesh filters 304 may be a magnetic mesh filter comprising a plurality of magnetic woven wires capable of magnetic filtration and barrier filtration. The wires forming the mesh may be made of material having magnetic characteristics such that the mesh filter 304 produces a magnetic field capable of attracting ferromagnetic particles contained in the oil. For instance, the wires forming the mesh may be made of a magnetic stainless steel, such as ferritic stainless steel, martensitic stainless steel, or duplex stainless steel. The magnetic stainless steel may be an alloy including ferritic or martensitic crystal structures to provide magnetic properties, such as 430 grade stainless steel. The optional additional layer of mesh filter 306 may be made of a sintered metal fiber felt.

In one embodiment, one or both of the wire mesh filters 304 of the filter element 300 may comprise a coated mesh filter, which may be used in combination with a magnetic or non-magnetic mesh filter. The coated mesh filter may comprise a plurality of woven wires coated with a hydrophobic material adapted to allow the passage of oil through the openings of the coated mesh filter and to prevent the passage of water through the coated mesh filter. For instance, the wires forming a woven mesh filter 304 may be coated with a polytetrafluoroethylene (PTFE) resin or a similar hydrophobic material to provide a hydrophobic filter element that separates oil from any water that may have contaminated the oil. The coating may be a thin coating that does not close any of the openings in the mesh. The coating may cause water to bead on the surface of the mesh while allowing other liquid to pass through the mesh.

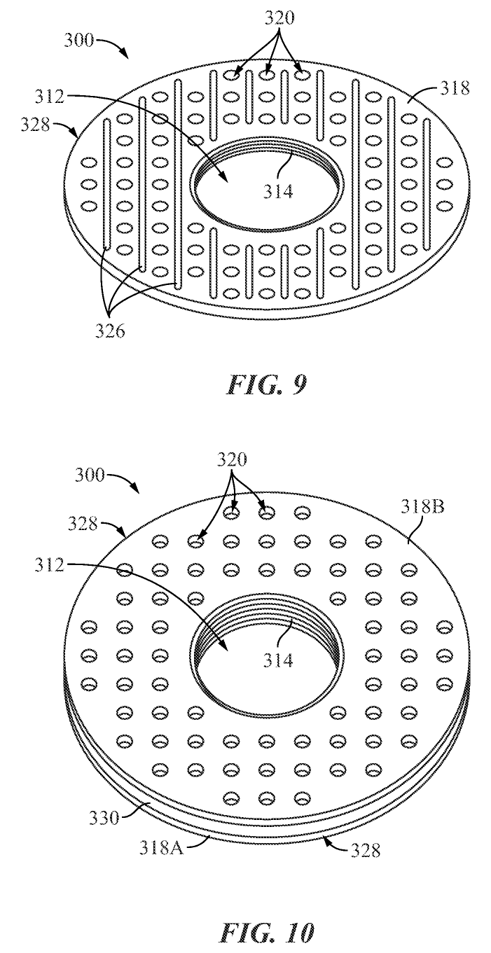

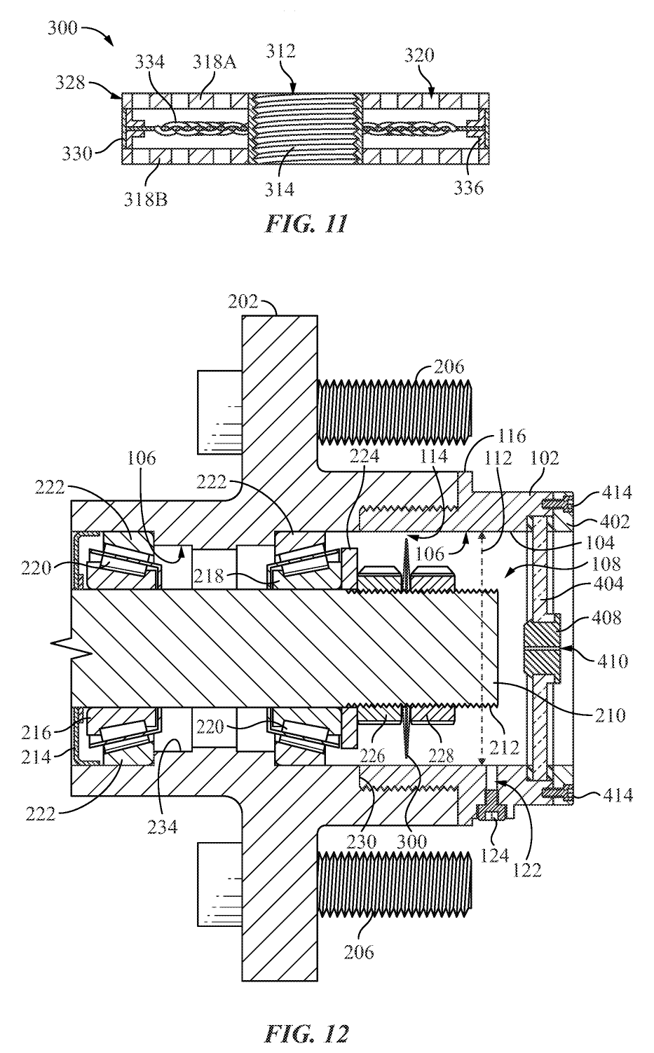

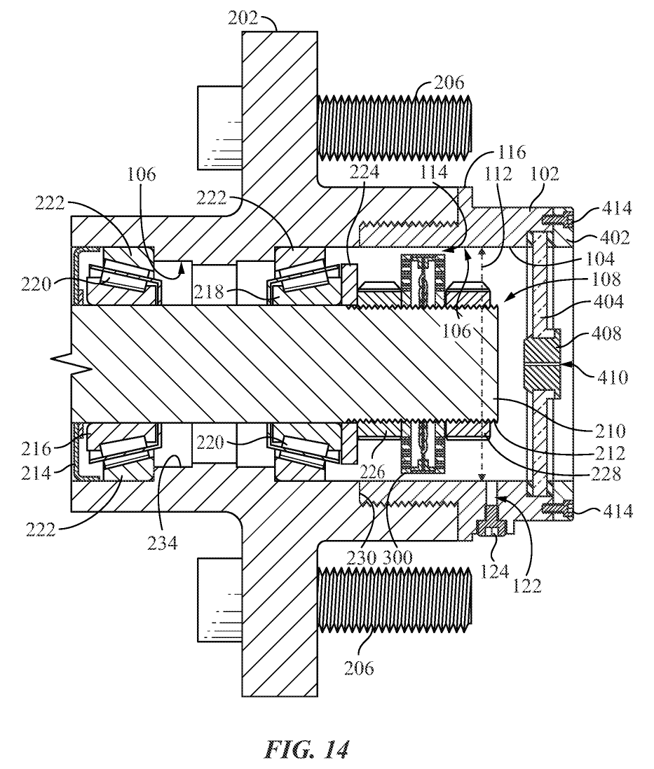

FIGS. 7-11 illustrate a filter element 300 comprising one or more baffle plates 318 each having a plurality of openings 320 extending through the baffle plate 318 to allow oil to flow through the openings 320. Each of the filter elements 300 has a central opening 312 that extends through the filter element 300. Similar to the disc filter element 300 shown in FIGS. 4-6, the end portion 210 of the axle 204 may be received within the central opening 312 and inserted through the central opening 312 to install the filter element 300 on the end portion 210 of the axle 204. The central opening 312 of the filter element 300 is generally sized to fit around the end portion 210 of the axle 204 with the filter element 300 being disposed around an exterior of the end portion 210 of the axle 204 such that the end portion 210 of the axle 204 extends through the central opening 312 in the filter element 300. The central opening 312 of each filter element 300 is preferably defined by a threaded opening having helical threads 314 for threading the filter element 300 onto the helical threads 212 on the end portion 210 of the axle 204 to retain the filter element 300 in a fixed axial position on the end portion 210 of the axle 204. FIG. 13 shows the filter element 300 shown in FIGS. 7 and 8 installed on the end portion 210 of the axle 204, and FIG. 14 shows the filter element 300 shown in FIGS. 10 and 11 installed on the end portion 210 of the axle 204. Alternatively, the central opening 312 may be sized to provide a transition fit between the filter element 300 and the end portion 210 of the axle 204 so that a user can manually slide the filter element 300 onto the end portion 210 of the axle 204 with minimal, if any, clearance between the filter element 300 and the end portion 210 of the axle 204 so that the fit generally does not allow movement of the filter element 300 within the oil enclosure 108 in a radial direction relative to axis 250.

The baffle plate 318 may include magnetic elements attached to the baffle plate 318 for removal of ferromagnetic contaminants primarily. In one embodiment, as shown in FIGS. 7 and 8, the filter element 300 may comprise a generally flat baffle plate 318 and a plurality of ring-shaped magnets 322 each attached to the baffle plate 318 and each having an opening extending through the ring-shaped magnet 322. Each opening extending through a respective one of the plurality of ring-shaped magnets 322 may define a respective one of a plurality of openings 320 extending through the baffle plate 318. FIG. 8 shows an exploded view of the filter element 300 with one of the plurality of magnets 322 removed from the baffle plate 318. The baffle plate 318 may be a generally circular disc having a plurality of circular openings 324 sized to receive a respective one of the ring-shaped magnets 322 therein. When installed within one of the openings 324, surfaces on opposing sides of each of the ring-shaped magnets 322 may be generally flush with exterior surfaces on opposing sides of the baffle plate 318. Each of the ring-shaped magnets 322 may be press-fit into one of the openings 324 in the baffle plate 318 or otherwise attached to the baffle plate 318. The openings 320 defined by the magnets 322 and extending through the assembled baffle plate 318 allow the oil to flow across the filter element 300 while increasing the surface area that contacts the oil for magnetic separation of ferromagnetic contaminants from the oil.

Alternatively, as shown in FIG. 9, the filter element 300 may comprise a generally flat baffle plate 318 and a plurality of magnetic elements 326 attached to an exterior surface of the baffle plate 318. The magnetic elements 326 may comprise sheets of magnetic material formed into strips and attached to the exterior surface of the baffle plate 318 on at least one side of the baffle plate 318, and preferably on at least the proximal side of the baffle plate 318 when the baffle plate 318 is secured to the end portion 210 of the axle 204 on a distal side of the outer bearing 218. The magnetic strips 326 may be positioned on the surface of the baffle plate 318 in rows between rows of openings 320 in the baffle plate 318. The openings 320 extending through the baffle plate 318 allow the oil to flow across the filter element 300 while the oil also contacts the magnetic strips 326 for magnetic separation of ferromagnetic contaminants.

FIGS. 10 and 11 illustrate a filter element 300 comprising two opposing baffle plates 318A and 318B each having a plurality of openings 320 extending through each of the two baffle plates 318A and 318B to allow oil to flow through the openings 320 of both baffle plates and through the filter element 300. The two opposing baffle plates 318A and 318B may be disposed generally parallel to each other, and a sidewall 330 may extend between the two baffle plates 318A and 318B and attach the baffle plates 318A and 318B to each other. The sidewall 330 may be a continuous sidewall 330 extending around an outer peripheral edge 328 of each of the two circular baffle plates 318A and 318B or may optionally have openings in the sidewall 330. Similar to the single baffle plates 318 shown in FIGS. 7-9, one or both of baffle plates 318A and 318B may optionally have magnetic elements 322, 326 attached to a surface of the baffle plate 318A, 318B. Alternatively, one or both of baffle plates 318A and 318B may be made of magnetic stainless steel or a similar material having magnetic characteristics.

As shown in FIG. 11, the filter element 300 may further comprise barrier filtration media disposed between the opposing baffle plates 318A and 318B. The barrier filtration media 334 may comprise any type of filtration media suitable for physical removal of contaminants such as dirt and debris from oil contained within a wheel hub for lubricating wheel bearings. The barrier filtration media preferably comprises a surface filter 334 but may optionally include depth filter media instead or both a surface filter 334 and a depth filter. The surface filter 334 may comprise a woven wire mesh filter, which may be the same or similar to wire mesh filter 304 utilized with the disc filter element 300 shown in FIGS. 4-6. Thus, the surface filter 334 may comprise a plurality of woven wires having a plurality of openings extending through the mesh and being defined by spaces between the woven wires. The woven wires may be made of stainless steel, copper, or another suitable material. The woven wires may be sintered so that the individual wires are bonded to each other at each intersection of wires. The mesh filter 334 may be a magnetic mesh filter comprising a plurality of magnetic woven wires capable of magnetic filtration and barrier filtration. The mesh filter 334 may be secured to an interior side of the sidewall 330 of the filter element 300 using clips 336 or another suitable type of fastener to retain the mesh filter 334 in a fixed position between the baffle plates 318A and 318B of the filter element 300.

Optionally, depth filter media may be disposed between baffle plates 318A and 318B and may comprise a wire wool material, such as stainless steel wool, or a similar type of filtration material comprising entwined filaments that are agglomerated to form a depth filter having passageways capable of retaining various types of contaminants throughout the filtration media. The depth filter media may have a density that provides passageways having a size through which the oil may flow through the media as the oil splashes and otherwise moves within the oil enclosure 108 during operation of the vehicle. In some embodiments, the depth filter media may comprise cellulose fibers, synthetic glass fibers, polyester fibers, or other types of natural or synthetic fibers.

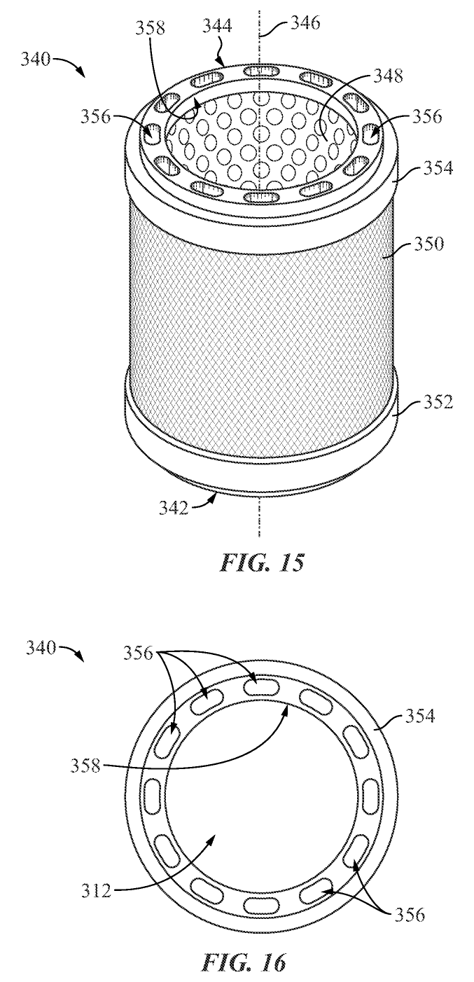

FIGS. 15 and 16 show an alternative embodiment of a filter element 340 having an elongated shape configured to be installed on a section 210A of the end portion 210 of the axle 204 that is disposed between the inner bearing 216 and the outer bearing 218. Thus, when installed, the filter element 340 is disposed within the portion 108A of the oil enclosure 108 that is also disposed between the inner bearing 216 and the outer bearing 218. FIG. 17 shows filter element 340 installed on the end portion 210 of the axle 204. The elongated filter element 340 has a proximal end 342 and a distal end 344. The central opening 312 of the filter element 340 extends through the filter element 340 from the proximal end 342 of the filter element 340 to the distal end 344 of the filter element 340 along a longitudinal axis 346 of the filter element 340.

As best seen in FIG. 15, the filter element 340 may comprise a perforated sheet 348 arranged radially around the longitudinal axis 346 of the filter element 340 and having a plurality of openings within the perforated sheet 348 to allow oil to flow through the perforated sheet 348. The filter element 340 may further comprise a surface filter, which is preferably a mesh filter 350, arranged radially around the longitudinal axis 346 of the filter element 340 and disposed at a radially outward position relative to the perforated sheet 348. The perforated sheet 348 and the mesh filter 350 may be attached to each other by a first support ring 352 disposed at the proximal end 342 of the filter element 340 and by a second support ring 354 disposed at the distal end 344 of the filter element 340. Support rings 352 and 354 may attach the perforated sheet 348 and mesh filter 350 in an arrangement in which there is a small gap between the perforated sheet 348 and the mesh filter 350. Each of the first and second support rings 352 and 354 preferably has a plurality of openings 356 extending through each of the first and second support rings 352 and 354 in an axial direction relative to the longitudinal axis 346 of the filter element 340 in a radially inward position relative to the perforated sheet 348.

The perforated sheet 348 is preferably made of a non-permeable material such as metal, and the oil may flow through the openings in the perforated sheet 348. The mesh filter 350 may preferably comprise a woven wire mesh filter, which may be the same or similar to wire mesh filter 304 or 334 as described herein. In some embodiments, filter 350 may comprise cellulose fibers, synthetic glass fibers, polyester fibers, or other types of natural or synthetic fibers. Each of the first and second support rings 352 and 354 preferably has an inner edge having an inner surface 358 disposed at a radially inward position relative to the perforated sheet 348, which may result in a gap between the perforated sheet 348 and the section 210A of the end portion 210 of the axle 204 on which the filter element 340 is installed, as best seen in FIG. 17. Oil may flow into this gap through openings 356 in support rings 352 and 354. Inner surfaces 358 may define a minimum diameter of the central opening 312 extending through the filter element 340. The diameter of the central opening 312 at the inner surfaces 350 of support rings 352 and 354 may be sized to provide a transition fit between the filter element 340 and section 210A of the end portion 210 of the axle 204 so that a user can manually slide the filter element 340 onto the end portion 210 of the axle 204 with minimal, if any, clearance between the filter element 340 and the end portion 210 of the axle 204 so that the fit generally does not allow movement of the filter element 340 within the oil enclosure 108 in a radial direction relative to axis 250. The filter element 340 may be installed on the end portion 210 of the axle 204 after installation of the inner bearing 216 and before installation of the outer bearing 218. During use of the vehicle, oil contained within the oil enclosure 108 may move through openings 356, through the perforated sheet 348, and through the mesh filter 350 to remove contaminants from the oil.

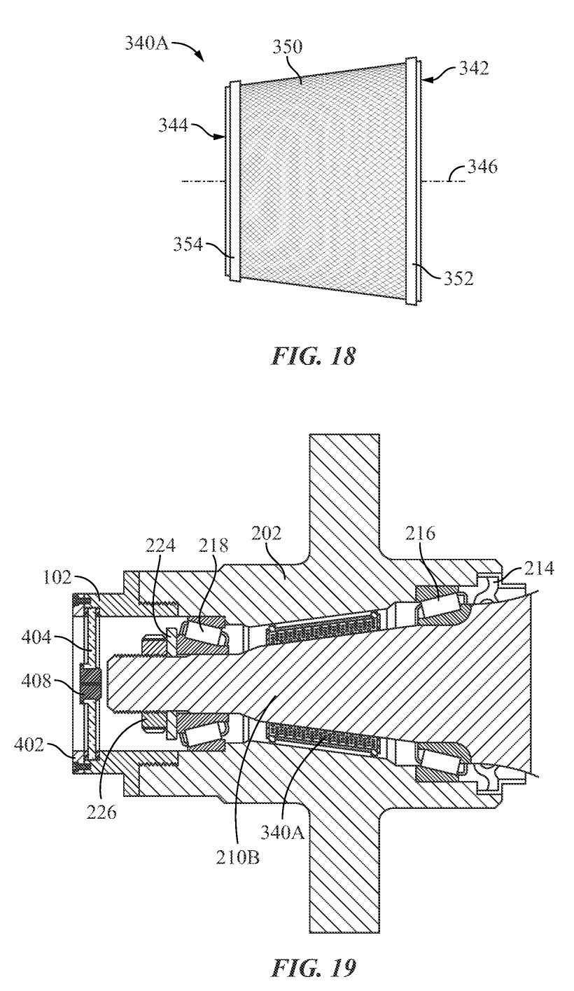

FIG. 18 shows an alternative embodiment of an elongated filter element 340A that is tapered so that the filter element 340A fits onto a tapered end portion 210B of an axle 204, and FIG. 19 shows filter element 340A installed on the tapered end portion 210B of the axle 204. The filter element 340A is tapered as the filter element 340A extends from the proximal end 342 of the filter element 340A toward the distal end 344 of the filter element 340A. The section 210B of the end portion 210 of the axle 204 disposed between the inner bearing 216 and the outer bearing 218 is tapered as the section 210B extends from the inner bearing 216 toward the outer bearing 218. In tapered filter element 340A, support ring 352 at the proximal end 342 may have a larger diameter than the support ring 354 at the distal end 344 so that opening 312 is larger at the proximal end 342 of the filter element 340A than at the distal end 344. Inner surfaces 358 of support rings 352 and 354 may be angled relative to axis 346 so that the surfaces 358 fit against the tapered section 210B of the end portion 210 of the axle 204 in a transition fit. The angle of the perforated sheet 348, mesh filter 350, and surfaces 358 relative to axis 346 may be varied to fit a specific tapered section 210B of an axle 204 in a transition fit. The tapered filter element 340A may be installed on the tapered section 210B of the axle 204 after installation of the inner bearing 216 and before installation of the wheel hub 202 or outer bearing 218 by sliding the tapered filter element 340A onto the tapered section 210B of the axle 204.

In an alternative embodiment, the wheel hub assembly 200 may include a filter element 300 installed on the axle 204 at a position distal to the outer bearing 218 and additionally a second filter element 340, 340A installed on the axle 204 at a position between the inner bearing 216 and the outer bearing 218.

It will be appreciated that the configurations and methods shown and described herein are illustrative only, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein. It is understood that versions of the invention may come in different forms and embodiments. Additionally, it is understood that one of skill in the art would appreciate these various forms and embodiments as falling within the scope of the invention as disclosed herein.

What is claimed is:

1.) A wheel hub assembly, comprising:
an axle;
a wheel hub rotatably coupled to the axle;
a hubcap mounted onto the wheel hub, wherein an interior volume of the wheel
hub and the hubcap define an oil enclosure, wherein an end portion of the axle is disposed within the oil enclosure; and
a filter element disposed within the oil enclosure,
wherein the filter element has a central opening extending through the filter
element, wherein the central opening of the filter element is sized to fit around the end portion of the axle, wherein the filter element is disposed around an exterior of the end portion of the axle with the end portion of the axle extending through the central opening in the filter element.

2.) The wheel hub assembly of claim 1, wherein the end portion of the axle has a threaded section having helical threads.

3.) The wheel hub assembly of claim 2, further comprising a threaded fastener having helical threads that are compatible with the helical threads on the end portion of the axle, wherein the threaded fastener is configured to retain the filter element in a fixed position on the end portion of the axle.

4.) The wheel hub assembly of claim 2, wherein the central opening of the filter element is defined by a threaded opening having helical threads, wherein the helical threads of the threaded opening of the filter element are compatible with the helical threads on the end portion of the axle.

5.) The wheel hub assembly of claim 1, wherein the filter element comprises a mesh filter.

6.) The wheel hub assembly of claim 5, wherein the mesh filter comprises a plurality of magnetic woven wires.

7.) The wheel hub assembly of claim 1, wherein the filter element comprises at least one baffle plate having a plurality of openings extending through the at least one baffle plate, wherein the at least one baffle plate has a magnet attached to the at least one baffle plate.

8.) The wheel hub assembly of claim 1, wherein the filter element comprises two opposing baffle plates, wherein each respective one of the opposing baffle plates has a plurality of openings extending through the baffle plate, wherein the filter element further comprises barrier filtration media disposed between the opposing baffle plates.

9.) The wheel hub assembly of claim 1, further comprising an inner bearing and an outer bearing, wherein the inner bearing and the outer bearing support the wheel hub on the axle, wherein a portion of the oil enclosure is disposed between the inner bearing and the outer bearing, wherein the filter element is disposed around the exterior of a section of the end portion of the axle disposed between the inner bearing and the outer bearing.

10.) The wheel hub assembly of claim 9, wherein the filter element has an elongated shape having a proximal end and a distal end, wherein the central opening of the filter element extends through the filter element from the proximal end of the filter element to the distal end of the filter element along a longitudinal axis of the filter element.

11.) The wheel hub assembly of claim 10, wherein the filter element is tapered as the filter element extends from the proximal end of the filter element toward the distal end of the filter element, wherein the section of the end portion of the axle disposed between the inner bearing and the outer bearing is tapered as the section extends from the inner bearing toward the outer bearing.

12.) The wheel hub assembly of claim 10, wherein the filter element comprises a perforated sheet arranged radially around the longitudinal axis of the filter element, wherein the filter element further comprises a mesh filter arranged radially around the longitudinal axis of the filter element, wherein the mesh filter is disposed at a radially outward position relative to the perforated sheet.

13.) The wheel hub assembly of claim 12, wherein the perforated sheet and the mesh filter are attached to each other by a first support ring disposed at the proximal end of the filter element and by a second support ring disposed at the distal end of the filter element, wherein each of the first and second support rings has a plurality of openings extending through each of the first and second support rings in an axial direction relative to the longitudinal axis of the filter element.

14.) The wheel hub assembly of claim 1, wherein the hubcap comprises a hubcap body having an open distal end and a cap assembly configured to cap the open distal end of the hubcap body.

15.) The wheel hub assembly of claim 14, wherein the cap assembly comprises a fastening ring, a transparent viewing window having an opening extending through the viewing window, and a plug, wherein the plug is configured to be installed within the opening in the viewing window to seal the opening in the viewing window.

16.) The wheel hub assembly of claim 15, wherein the plug has a pressure relief opening extending through the plug.

17.) The wheel hub assembly of claim 14, wherein the hubcap body has helical threads configured to mate with helical threads on the wheel hub.
